(19) United States
(12) Patent Application Publication
(10) Pub. No.: US 2004/0197001 A1
(43) Pub. Date: Oct. 7, 2004

(54) Earbag hanging earphones

(76) Inventor: Nicholas Keith Terrell, Arlington Heights, IL (US)

Correspondence Address: NICHOLAS K. TERRELL, 2116 N. YALE AVE., ARLINGTON HEIGHTS, IL, 60004, US

(21) Appl. No.: 10/249,358

(22) Filed: Apr. 2, 2003

(51) Int. Cl. H04R 25/00

(52) U.S. Cl. 381/370; 381/371; 381/374

(57) ABSTRACT

A headphone device comprised of two separate units which hang on each ear by means of capturing the edge of the top and rear portions of the ear between a flexible ring and attached cloth. Each side is slid onto the ear and firmly held in place by the positioning of the ring, rather than compressive force, which is found in current headphone devices. The speaker element is connected to the cloth on the outer side of the device.

### BACKGROUND OF INVENTION

This invention pertains to the field of audio devices known as headphones. Currently in this field are four types of devices, each with undesirable features. First among these are the headphones which incorporate a band over the top or around the back of the head, applying pressure to the skull in order to secure the speaker elements near the ear or ears. This design can become uncomfortable after extended usage, as it necessarily applies a compressive force to the head of the user. The second main type of headphones are those which wrap a wire or other piece around the back of the ear to maintain proper positioning. These are easily entangled with the ear supports of most eyeglasses, and can be as uncomfortable as the first type of earphones after even short periods. Third among these main types are those devices which fit directly into the outer ear, relying upon compression of the ear to hold their position. This necessary force applied on the ear again leads to discomfort when used over extended periods. The final type are those which are comprised of a plastic sheath which hangs on the ear, such as those used for translation in meetings of the United Nations. While solving the problems raised above, this type does not fit the contour of the ear and so is not suitable for use when moving, as such devices can easily fall off. These four types comprise the current state of earphone production.

### SUMMARY OF INVENTION

This invention solves each of the problems above by its design as a covering which surrounds the ear, without pressing or clamping onto the head or ear. The lack of compressive force and the maintenance of position allow for a more comfortable and dependable device that may be used for extended periods without discomfort. This is achieved by mounting a speaker element to the cloth stretched between an oval ring. The edge of the ear is then trapped between the ring and the cloth, keeping the device in position. Additionally, the cloth layer between the electronic speaker element and the ear provides a more natural sound by filtering and distorting the sound in a manner similar to that which occurs when the signal must travel through a room or other open space.

### BRIEF DESCRIPTION OF DRAWINGS

FIG. 1 is a view of one solid ring only, viewed from the side of the ear as it would normally be positioned when in use.

FIG. 2 is a view of one of the pair when finished showing particularly the opening into which the ear is placed, seen from the view of the ear as it would be positioned when in use.

FIG. 3 is a cross section of the finished device as seen from either the front or rear of the head when being worn, the various components are displayed in position though abstracted.

FIG. 4 is another cross section of the finished device, this time showing the pair as they would be worn from either front or rear of the user's head.

### DETAILED DESCRIPTION

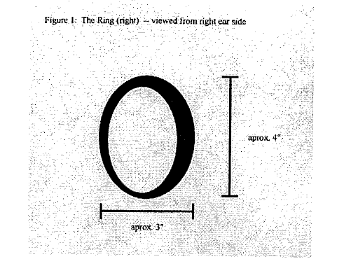

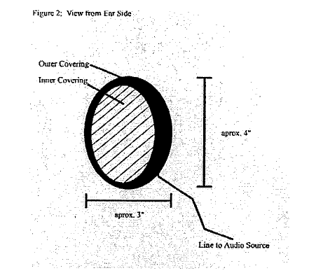

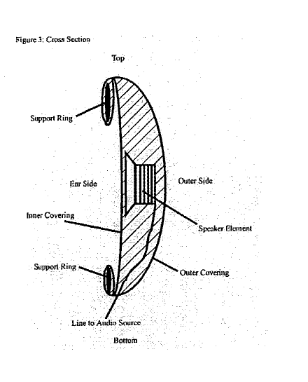

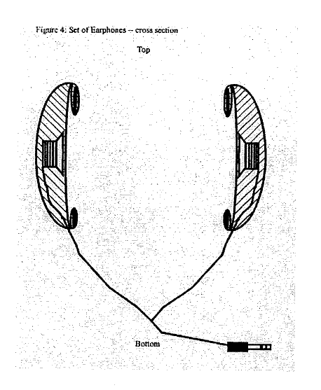

The device is composed of two nearly elliptical ring, two speaker elements with wiring, four square pieces of cloth between three and six inches on each side, and a small amount of stuffing material. To manufacture the device, it suffices to manufacture the two sides separately before combining them. In order to make the right side, a ring (FIG. 1) should first be cut of a flexible plastic, approximately 2 mm thick. This ring should then be covered by a piece of cloth (cut to fit the shape) in such a way as to wrap around the ring, so that it may be sewn together at the outer edge of the ring. After sewing the cloth in that fashion, fasten the speaker element to the outer side by sewing the element in place at the center of the cloth. Next, the stuffing material (cotton, foam, or other such light weight and acoustically absorbent material) should be placed around the speaker element to minimize the sound that bleeds out away from the ear, and the outer layer of cloth should then be sewn over it. The wire from the speaker element should be allowed to pass between the two layers of cloth at the bottom of this part of the device (FIG. 2). If properly done, the resulting piece of the device should appear as shown in the cross sectional view in FIG. 3. The same should be done, with the horizontal orientation of the ring reversed, to produce the left ear piece. Finally, the wires from both pieces should be connected to the desired connector, for use with an audio source (FIG. 4).

1. A headphone comprising:
a pair of combination speaker and positioning units which hang from the ears by means of loosely encapsulating the entirety of the upper and rear edges of each ear; and
a connecting wire, running to the bottom or back side of each unit.

2. The headphone according to claim 1, wherein each combination speaker and positioning unit is supported by a full ring of a solid and flexible material.

3. The headphone according to claim 1, wherein each speaker element separated from the ear by, and attached to, the cloth which partially encapsulates the edge of that ear.
